(19) United States
(12) Patent Application Publication
(10) Pub. No.: US 2019/0305322 A1
(43) Pub. Date: Oct. 3, 2019

(54) HIGH SURFACE AREA, HIGHLY CONDUCTIVE THREE-DIMENSIONAL POROUS ELECTRODES FOR ELECTROCHEMICAL REACTION APPLICATIONS

(71) Applicant: DUKE UNIVERSITY, Durham, NC (US)

(72) Inventors: Benjamin WILEY, Durham, NC (US); Myung Jun KIM, Durham, NC (US)

(21) Appl. No.: 16/373,466

(22) Filed: Apr. 2, 2019

Related U.S. Application Data
(60) Provisional application No. 62/651,282, filed on Apr. 2, 2018.

(51) Int. Cl. H01M 4/74; H01M 8/18; H01M 4/66; H01M 4/04

(52) U.S. Cl. CPC H01M 4/74; H01M 8/188; H01M 2004/021; H01M 4/0433; H01M 4/0471; H01M 4/661

(57) ABSTRACT

A three-dimensional (3D) porous nanowire electrode can include a plurality of nanowires arranged in a 3D mesh configuration within a defined area. The diameter of each nanowire is within a range of 10 nm-1000 nm. The nanowires are sintered to each other at points of contact in the 3D mesh configuration. The 3D porous electrodes can be used in a variety of electrochemical reactor systems, such as reduction-oxidation batteries, water treatment systems, and electrochemical organic synthesis systems.

### CROSS-REFERENCE TO RELATED APPLICATIONS

The present application claims the benefit of U.S. Provisional Application Ser. No. 62/651,282, filed Apr. 2, 2018 which is hereby incorporated by reference in its entirety, including any figures, tables, and drawings.

### GOVERNMENT SUPPORT

This invention was made with government support under Federal Grant No. 1253534 awarded by National Science Foundation (NSF). The U.S. Government has certain rights to this invention.

### BACKGROUND

Electrochemical reactors involve conversion between electrical energy and chemical energy and generally include an anode with a current connection (e.g., connected to a supply), electrolyte (and separator), and a cathode with a current connection (e.g., connected to a supply). Flow electrochemical processes are used in many electrochemical reactor applications such as reduction-oxidation (redox) batteries, water treatment systems, electrochemical sensors, and electrochemical organic synthesis.

One of the hurdles to increasing the utilization of electricity for chemical production is the volumetric productivity of electrochemical processes (i.e., the production rate of product per unit volume) scales with the surface area of the electrode rather than the volume of the reactor. As a result, industrial electrochemical reactors tend to be much larger and more expensive than other types of reactors, such as those that use heat instead of electricity to cause a chemical reaction to occur. Increasing the volumetric productivity of electrochemical processes, and thus their economic benefits, has long been a central goal of electrochemical engineering.

### BRIEF SUMMARY

High surface area and highly conductive three-dimensional (3D) porous nanowire electrodes, and methods of making and using the 3D porous nanowire electrodes are described herein for electrochemical reactor applications. A 3D porous electrode can be formed using nanosized conductive fibers (“nanowires”). The described 3D porous electrode includes a plurality of nanowires arranged in a 3D mesh configuration within a defined area. The nanowires are sintered to each other at points of contact in the 3D mesh configuration. The diameter of the nanowires can be between 10 nm-1000 nm; and can be configured to provide a porosity of 70%-90% (or better).

An electrochemical reactor system can utilize at least one 3D porous electrode. Each 3D porous electrode in the electrochemical reactor system is configured for exposure to a fluid and is coupled to a power source. Example electrochemical reactor systems include, but are not limited to, reduction-oxidation (redox) batteries, water treatment systems, electrochemical sensors, and electrochemical organic synthesis systems.

A method of manufacturing a 3D porous nanowire electrode can include dispersing a plurality of nanowires in a solvent to form a nanowire solution. The diameter of the nanowires of the plurality of nanowires can be within a range of 10 nm-1000 nm. A freestanding nanowire electrode in a 3D mesh configuration can be formed from the nanowire solution; and annealed to remove surface oxide and sinter nanowires to each other at points of contact in the 3D mesh configuration.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an example nanowire electrode with enlarged view of a 3D mesh configuration.

FIG. 2 shows a process flow diagram illustrating 3D porous nanowire electrode fabrication.

FIG. 3 shows an example filter with 3D porous electrode.

FIG. 4 shows an example redox battery incorporating 3D porous electrodes.

FIG. 5 shows a plot of the resistivity of the Cu nanowire electrode after annealing at various temperatures under H₂ gas for 30 minutes.

FIG. 6 shows a plot of the thickness versus the weight of Cu nanowire electrodes, demonstrating the Cu NW electrodes have a relatively consistent porosity of 0.94 across this thickness range.

FIGS. 7A and 7B show surface and cross-sectional images of the Cu nanowire electrode (A) before and (B) after flow of deionized (DI) water at 30 ml/min.

FIG. 8 shows an example flow cell used to characterize the properties of the Cu nanowire electrode.

FIGS. 9A and 9B show plots of a prototype implementation. FIG. 9A shows cyclic voltammograms for the Cu nanowire electrode in N₂-purged 0.1 M HClO₄ aqueous electrolyte according to the scan rate. FIG. 9B shows the change in the capacitive current as a function of scan rate.

FIGS. 10A and 10B show plots for a prototype implementation. FIG. 10A presents the pressure drop across the Cu nanowire electrode and carbon paper as a function of flow rate. FIG. 10B shows a plot of Re versus flow rate, demonstrating that the flow was laminar for all flow rates studied (Re<<1).

FIG. 11 shows a limiting current up to 5.4 times higher was obtained for the Cu nanowire electrode relative to the carbon paper electrode using the flow reactor of FIG. 7.

FIG. 12 shows an example of a 3D printed undivided flow cell used to measure water permeability and the reduction of Cu ions and Alizarin Red S (ARS).

FIG. 13 shows a flow cell for electroorganic synthesis.

### DETAILED DESCRIPTION

High surface area and highly conductive three-dimensional (3D) porous nanowire electrodes (“NW electrodes”), and methods of making and using the 3D porous nanowire electrodes are described herein for electrochemical reactor applications. A porous electrode is an electrode that permits fluid through gaps or holes in its structure. A porous electrode is considered a “3D porous electrode” when the electrode structure can permit the flow of a fluid through both the length/width and the height of the electrode.

Electrochemical reactor applications benefit from a flow-through configuration in which a fluid, such as an electrolyte, flows through or along (when arranged for a flow-by) a three-dimensional (3D) porous electrode. Flow-through 3D porous electrodes can be advantageous over two-dimensional (2D) planar electrodes due to the finely divided nature of flow-through electrodes, which results in more surface area per unit volume than two-dimensional (2D) planar electrodes. The performance of flow-through electrodes increases with its specific surface area and mass transport coefficient. The flow-through efficiency is indirectly related to the diameter of the fibers forming the 3D porous electrode. Common flow-through electrodes include carbon paper and graphite felt, which are effectively porous mats with fibers having a diameter in the micrometer range (e.g., 10-μm-wide carbon fibers).

By decreasing the diameter of the fibers forming an electrode, the performance of the electrode can be improved. Indeed, reducing the size of the fibers to the nanoscale in 3D porous electrodes can increase the productivity of electrochemical processes.

A 3D porous electrode formed using nanosized conductive fibers (“nanowires”) is described herein. The nanowire material may be any electrical conductor, such as, but not limited to, copper, silver, gold, aluminum, tungsten, nickel, iron, stainless steel, platinum, tin, lead, titanium, ruthenium, iridium, and carbon. The described 3D porous electrode includes a plurality of nanowires arranged in a 3D mesh configuration within a defined area. The positions of the nanowires may be random, ordered, or a combination thereof. The defined area refers to the two-dimensional area forming the border, in an x-y plane, of the electrode. The height/thickness of the electrode may be based, for example, on the thickness of a mold constraining the nanowires within the defined area. Nanowires forming the porous electrode can have diameters of 10 nm-1000 nm. The range of diameters and the spread of those diameters for the nanowires of a single electrode may vary depending on implementation and/or method of fabrication. For example, in some applications, nanowires with diameters of between 50 nm and 100 nm may be used to fabricate an electrode. As another example, some nanowires within the 3D mesh may have diameters of about 50 nm; and other nanowires may have diameters of about 350 nm. The nanowires, of the plurality of nanowires, are sintered to each other at points of contact in the 3D mesh configuration. In some cases, coatings may be applied to exposed surfaces to inhibit oxidation or dissolving of the nanowire material in harsh environments. The coatings may be any suitable material including metals and carbon.

The 3D electrode can be a porous electrode with a porosity of at least 70%. The described techniques can be used to fabricate a 3D porous electrode with a porosity of 90% or more. The thickness of the 3D porous electrode can be at least 20 μm. In some cases, the maximum thickness is 10 cm. The lateral dimensions can range from 0.1 mm to 10 meters. For example, a 3D porous electrode can have a width of at least 100 μm.

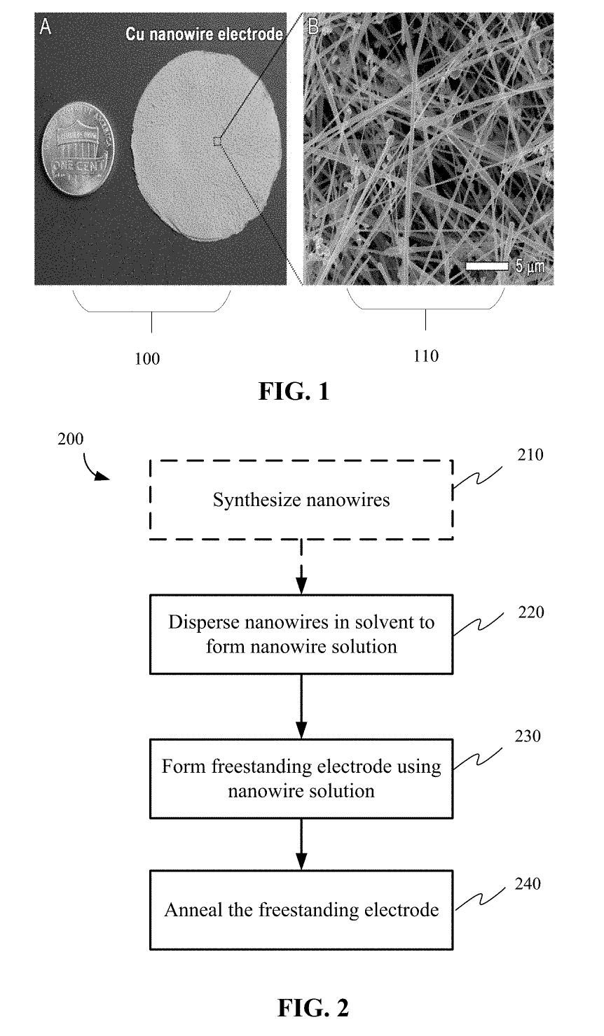

FIG. 1 shows an example of an enlarged view of a NW electrode. In this example, 100 shows a NW electrode with Cu nanowires. View 110 shows a scanning electron microscope (SEM) image of the NW electrode in which the individual Cu nanowires are visible in a 3D mesh configuration.

The NW electrode described herein can be manufactured in several ways. FIG. 2 shows a process flow diagram 200 illustrating 3D porous nanowire electrode fabrication. In some cases, nanowires may be purchased commercially. In other cases, nanowires may be synthesized as a preliminary manufacturing step 210. If the nanowires are synthesized as part of the manufacturing process, the nanowires can be synthesized by first preparing a reaction solution by sequentially adding a set of aqueous solutions into a vessel and then heating the vessel containing the reaction solution at an optimized temperature and for an optimized duration. The optimized temperature and optimized duration are dependent on the characteristics of the chosen nanowire material.

The manufacturing process flow 200 can begin with dispersing a plurality of nanowires in a solvent to form a nanowire solution 210. The nanowires can be dispersed into a solvent to create a random pattern (e.g., spaghetti in a pot filled with water) within the solvent 220. The solvent can be an organic solution, such as water, isopropyl alcohol (IPA), ethanol, methanol, or other organic solutions. Of course, the particular solvent is based on the particular nanowire material.

A freestanding nanowire electrode can be formed using the nanowire solution 230. In some cases, the freestanding nanowire electrode is formed by pouring the nanowire solution into a mold and drying the filled mold at room temperature. The mold may be made of a rubber sheet, PTFE sheet, or any kind of plastic and/or polymer. The mold can be a hole in the sheet, where the hole has a defined area, which corresponds to the desired shape of the nanowire electrode. The nanowire solution can be poured into the hole to fill the hole and then dried. Upon drying, the nanowire electrode can be detached from the mold. To fabricate nanowire electrodes with a higher porosity, the molds can first be filled to a specified volume with spherical polystyrene particles and then the remaining volume filled with the nanowire solution. After drying, the polystyrene particles can be selectively dissolved with appropriate organic solvents, such as toluene and benzene.

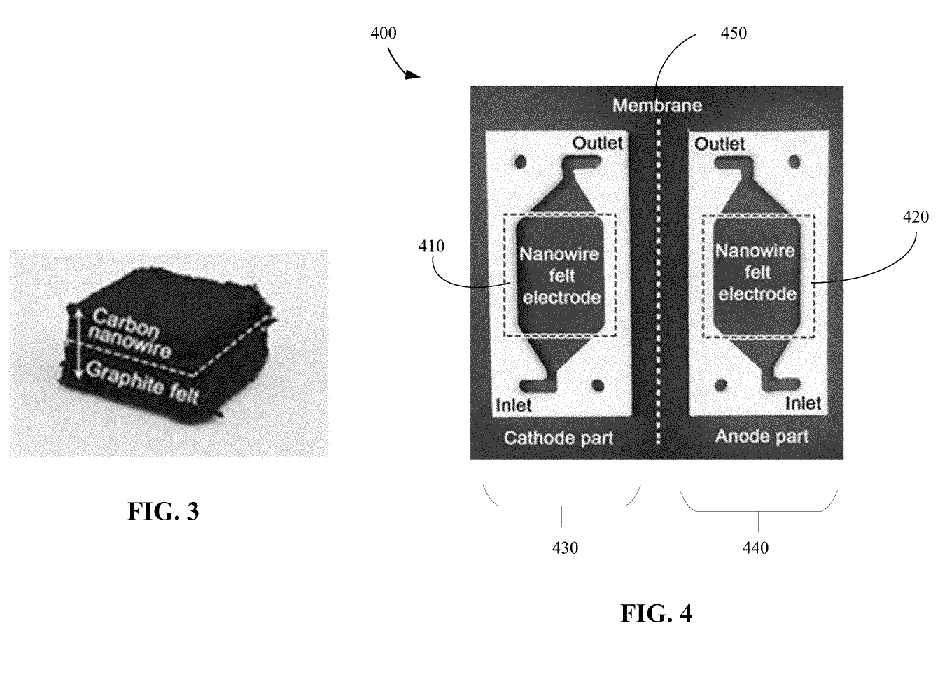

In some cases, the freestanding nanowire electrode is formed using a filtration of the nanowire solutions on mesh supports, membranes, carbon papers, or graphite felts. In some of such cases, the nanowires are suspended in aqueous or organic solvents, and poured into a filter fitted with a custom gasket. The gasket dictates the shape of the final filtered nanowire electrodes. A layered structure of filtered nanowire and carbon support can be obtained via filtering nanowire solutions on top of carbon paper or graphite felt, such as shown in the Example filter of FIG. 3, which can be also used as a flow-through electrode.

In some cases, the freestanding nanowire electrode is formed using a freeze-drying method. In one freeze-drying method, after pouring the nanowire solution into a mold, with or without polystyrene particles, the solution can be immediately frozen by dipping the mold containing the nanowire solution into liquid nitrogen. The frozen nanowire solution can be freeze dried under the conditions for water sublimation.

In some cases, the nanowires can be spray coated onto a substrate to create a “felt”. In an example implementation, nanowires can be first suspended in an appropriate solvent to form a nanowire solution. The nanowire solution is then loaded onto a pneumatic sprayer that can be controlled manually or automated. Multiple layers can be deposited to control the thickness of the nanowire “felt” electrode.

In some cases, the freestanding nanowire electrode can be made by 3D printing. For example, a thermoplastic-nanowire composite can be prepared by dissolving a thermoplastic with an appropriate organic solvent to form a thermoplastic solution and incorporating the nanowires (which themselves may be suspended in an appropriate solvent) into the thermoplastic solution. The composite is solidified following a drying process wherein the organic solvent is removed. The solid composite can be extruded into a filament compatible with commercial 3D printers. The 3D printers can then print a thermoplastic composite containing nanowires into a desired shape. The thermoplastic can then be removed to reveal the freestanding nanowire electrode. The thermoplastic may be removed, for example, by combustion, an organic solvent, or by a plasma etching process. Accordingly, in some cases, forming the freestanding nanowire electrode comprises performing a 3D printing process using a thermoplastic-nanowire composite formed using the nanowire solution and a thermoplastic.

After forming the freestanding nanowire electrode, an annealing process 240 is performed. Before annealing, the freestanding NW electrode is often not yet mechanically strong or electrically conductive because the nanowires in the freestanding NW electrode are weakly connected to each other and, in some cases, a thin oxide layer may have formed on the surface of the nanowires, which blocks transport of electrons between nanowires. The annealing process can remove the surface oxide and sinters points of contact of the plurality of nanowires within the nanowire electrode. After annealing, the NW electrode can retain its structure and not collapse or disperse during flow-through applications. In the case of forming the NW electrode via 3D printing, the annealing step also serves to combust the thermoplastic. Heating the nanowires can partially melt or break the nanowires, so the annealing temperature is optimized to find the minimum electrical resistivity that results from the trade-off between sintering and melting. For example, in one process, an optimal temperature for annealing Cu nanowires was experimentally determined to be 350° C. for 30 minutes under H₂ gas. It should be understood that any temperatures described herein for the annealing process may be approximate or at least within acceptable tolerances unless otherwise specified.

The 3D porous electrode can be employed in a variety of electrochemical processes and systems. Examples of such processes and systems can include organic electrosynthesis, water electrolysis, water treatment, electrochemical sensors, fuel cells and redox flow batteries. An electrochemical reactor system that performs these processes can include at least one 3D porous electrode that is configured for exposure to a fluid and coupled to a power source.

FIG. 4 shows an example redox battery incorporating 3D porous electrodes. The redox battery 400 illustrates a parallel flow-through configuration using a first NW electrode 410 and a second NW electrode 420. The redox battery comprises a cathode compartment 430 and an anode compartment 440. The first NW electrode 410 is disposed in a cathode compartment 430 and the second NW electrode is disposed in the anode compartment 440. Each NW electrode is configured for exposure to a fluid within its corresponding compartment and is coupled to a power source to provide current, for example. The cathode compartment receives a first fluid into the cathode inlet. The first fluid passes through the first NW electrode 410 and exits at the cathode outlet. The anode compartment 440 receives a second fluid into the anode inlet. The second fluid passes through the second NW electrode 420 and exits at the anode outlet 480. A membrane 450 is positioned between the cathode compartment 430 and anode compartment 440. With this parallel flow-through configuration, each NW electrode can be used for two different reactions (one will be a reduction reaction and the other will be an oxidation reaction).

### Experimental Examples

An experimental example of the manufacture of a 3D porous NW electrode made from nanowires is described. In this example, the nanowires are composed of Cu, however, depending on the application, the nanowires forming the porous electrode can be composed of any suitable conductive material. Characterizations of the physical properties of the Cu NW electrode are also described in this example.

In this experimental example, the manufacture of the NW electrode begins with synthesis of the Cu nanowires. For synthesis, a reaction solution was prepared by sequentially adding the following four aqueous solutions in a 2 L glass bottle: (1) 1500 ml of 8 M NaOH (NOAH Technologies, 99%), (2) 160 ml of 0.1 M Cu(NO₃)₂ (Sigma-Aldrich, 98%), (3) 23 ml of ethylenediamine (EDA, Acros Organics, 99%), and (4) 150 ml of 1 g/l ml α-D-glucose (Sigma-Aldrich, 96%). The final concentrations of NaOH, Cu(NO₃)₂, EDA, and glucose were 12.3 M, 8.73 mM, 186 mM, and 450 mM, respectively. After mixing the solutions, the glass bottle was immediately placed in a 60° C. oven for 4 hrs.

After the reaction, Cu NWs were cleaned with an aqueous solution containing 3 wt % polyvinylypyrrolidone (PVP, Mw=10,000, Sigma-Aldrich) and 1 wt % N,N-diethylhydroxylamine (DEHA, TCI, 98%). The NWs were stored in 3 wt % PVP, 1 wt % DEHA aqueous solution. The average diameter and length of synthesized Cu NWs were measured from the images obtained by field emission scanning electron microscope (FESEM, FEI XL30 SEM-FEG) and dark field optical microscope (DFOM, BX51, Olympus). The average diameter and length of the Cu NWs were 220±70 nm and 40±13 μm, respectively. The concentration of Cu NWs in the storage solution was measured by atomic absorption spectrophotometer (AAS, 3100 Perkin Elmer).

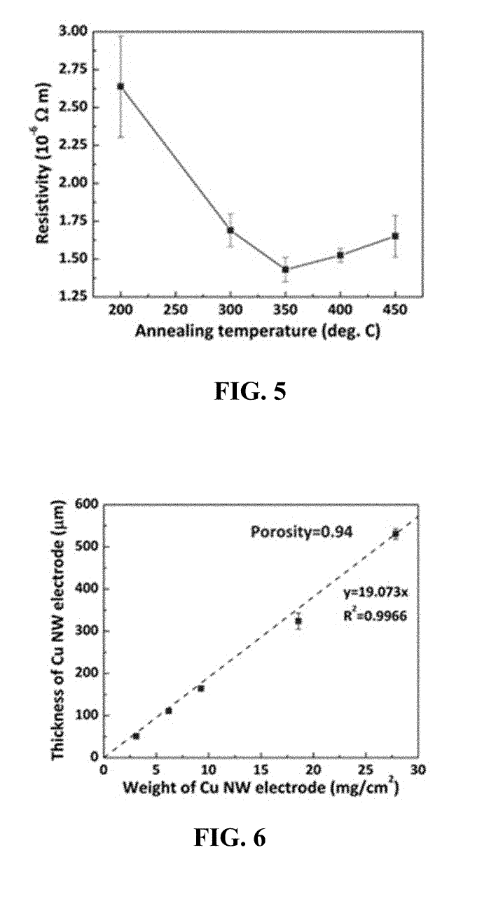

Prior to the fabrication of the NW electrode, Cu NWs were washed with isopropyl alcohol (IPA) using centrifugation and the removal of the supernatant three times. The clean Cu NWs were re-dispersed in IPA and then filtered onto stainless steel mesh via vacuum filtration to make the porous Cu NW electrode. The filtration area, 1.13 cm², was defined using a silicon gasket. After filtration, the Cu NW network was annealed at various temperatures for 30 min under H₂ gas. FIG. 5 shows a plot of the resistivity of the Cu NW electrode after annealing at various temperatures under H₂ gas for 30 minutes. As shown in the plot, the optimum temperature for annealing (350° C.) minimized the electrical resistivity of the Cu NW electrode. The optimization of annealing temperature was carried out with a 324 μm-thick Cu NW electrode. The electrical resistivity of 1.43×10⁻⁶ Ωm was calculated from the sheet resistance as measured with a 4-point probe, and the thickness was measured with SEM. At this condition, the Cu NW electrode is 22 times more conductive than carbon paper and 2100 times more conductive than graphite felt.

In addition to electrical conductivity, the porosity and the surface area are key characteristics of a flow-through electrode. The porosity (ε) can simply be calculated from the weight and the thickness of Cu NW electrode with equation 1,

$$ɛ = \frac{{V}_{void}}{{V}_{e}} = 1 - \frac{{V}_{Cu NW}}{{V}_{e}} \qquad ( 1 )$$

where V_{void} is the volume of void in porous electrode and V_{Cu NW} is the volume of Cu NWs (the total weight/the density of Cu). FIG. 6 shows a plot of the thickness versus the weight of Cu NW electrodes, demonstrating the Cu NW electrodes have a relatively consistent porosity of 0.94 across this thickness range.

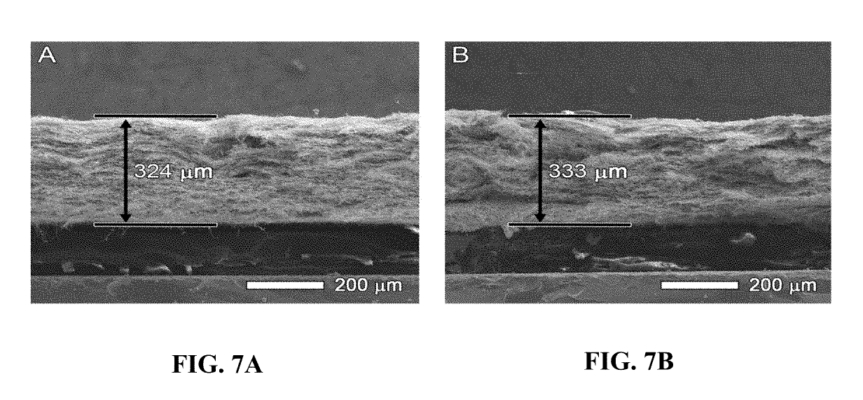

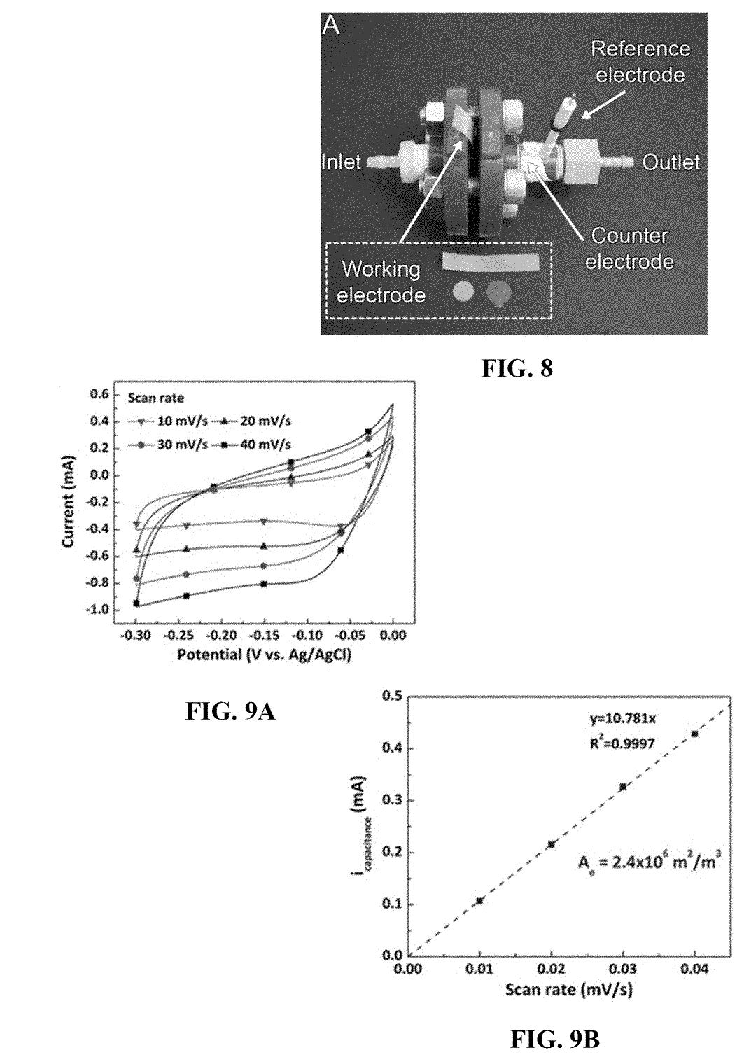

FIG. 7 shows surface and cross-sectional images of the Cu NW electrode (A) before and (B) after flow of deionized (DI) water at 30 ml/min. The images of the Cu NW electrode before and after the flow of fluid indicate that annealing of the Cu NW achieved sufficient mechanical strength and electrical resistivity for use as flow-through electrodes. The pressure driven by liquid flow through the porous electrode was measured by a pressure gauge (DPGW-05, Dwyer Instruments, Inc.) which was connected to the inlet of a flow cell. FIG. 8 shows an example flow cell used to characterize the properties of the Cu NW electrode. Without the porous electrode, the pressure was below the detection limit (0.01 psi) for all flow rates studied. A Cu NW electrode with a thickness of 324 μm and commercial carbon paper (370 μm thickness, TGP-H-120, manufactured by FuelCellsEtc) were placed between two flanges. Silicon gaskets were used to prevent the leakage of water.

The specific surface area of the Cu NW electrode was measured by cyclic voltammetry in 0.1 M HClO₄ (VWR, 70%) aqueous solution with a potentiostat (CHI600D, CH Instruments, Inc.). The solution was purged by N₂ for 30 min before the measurements. The inner diameter of the pipe in FIG. 8, which defined the cross-sectional area of the electrode, was 8 mm (cross sectional area=0.5 cm²). The working, reference, and counter electrodes were a 324-μm-thick Cu NW electrode, a Ag/AgCl electrode (CH Instruments, Inc.), and a Pt wire, respectively. Before starting the measurement, an electrolyte was pumped into the Cu NW electrode to remove the entrapped air. A peristaltic pump was used for flowing liquid through the Cu NW electrode. Cyclic voltammetry was performed with the potential between 0 V and −0.3 V with respect to Ag/AgCl reference electrode. The capacitive current (i_{capacitive}) was measured at various scan rates of cyclic voltammetry, and the surface area (A) was calculated from the following equation:

i_{capacitive}=AC_{d}v (2)

where C_{d} is theoretical capacitance (0.28 F/m²) for the double layer on Cu surface in 0.1 M HClO₄ and ν is scan rate (mV/s). The specific surface area was calculated by dividing A by the volume of electrode. FIGS. 9A and 9B show plots of a prototype implementation. FIG. 9A shows cyclic voltammograms for the Cu NW electrode in N₂-purged 0.1 M HClO₄ aqueous electrolyte according to the scan rate. FIG. 9B shows the change in the capacitive current as a function of scan rate.

The aqueous electrolyte consisted of 0.1 mM Cu(NO₃)₂ (Sigma-Aldrich, 98%) and 50 mM KNO₃ (Sigma-Aldrich, 99%). A Ag/AgCl electrode (CH Instruments, Inc.) and a Cu wire were used as the reference and counter electrodes, respectively. To make electrical contact between the porous electrode and the potentiostat, the stainless steel mesh (Stainless Steel Wire Cloth, 400 mesh, McMaster) was used as shown in FIG. 8. Chronoamperometry was performed with various flow rates at −0.5 V (vs. Ag/AgCl) for 30 s. The average current was obtained with the current values between 20 and 30 s of current-time curves.

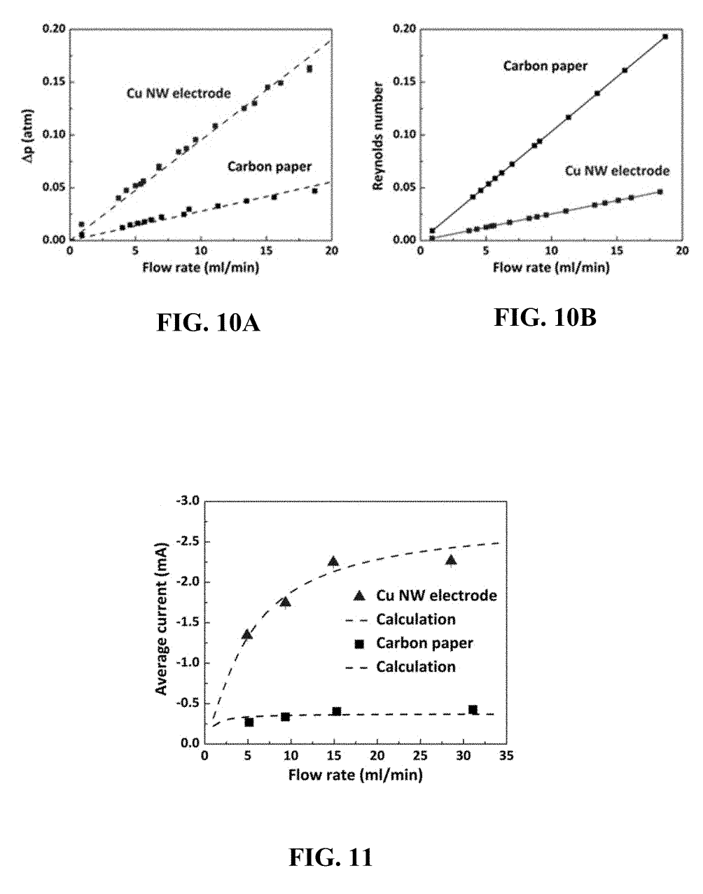

The permeability of a porous electrode determines the flow rate of electrolyte for a given applied pressure, and thus determines how much energy must be devoted to pumping fluid through the porous electrode. To determine the permeability of the Cu NW electrode, the pressure drop across the electrode as a function of flow rate was measured. FIGS. 10A and 10B show plots of a prototype implementation. FIG. 10A presents the pressure drop across the Cu NW electrode and carbon paper as a function of flow rate.

Assuming laminar flow, the permeability of a porous electrode can be calculated from Darcy's law with equation 3, where ν is superficial velocity (m/s), k is permeability (m²),

$$v = - \frac{k}{μ} \frac{Δ p}{Δ L} \qquad ( 3 )$$

Δp is pressure change, μ is the viscosity of water (kg/m·s), and ΔL is the length of porous electrode. To confirm we were in the laminar flow regime, the Reynolds number (Re) was calculated with equation 4, where ρ is density of water (997.2 kg/m³).

$$Re = \frac{ρ v}{( 1 - ɛ ) {A}_{e} μ} \qquad ( 4 )$$

FIG. 10B shows a plot of Re versus flow rate, demonstrating that the flow was laminar for all flow rates studied (Re<<1). From Darcy's law, the permeability for carbon paper and Cu NW electrode was found to be 4.33×10⁻¹³ m² and 1.12×10⁻¹³ m², respectively. Thus, the pressure drop across a Cu NW electrode will be 3.42 times higher than that across a carbon paper of the same thickness. This lower permeability is due to the much larger surface area of the Cu NW electrode relative to carbon paper.

To obtain a comparison of the electrochemical performance of the Cu NW electrode and the carbon paper electrode, the average current versus flow rate across a Cu NW and carbon electrode with an electrolyte solution consisting of 0.1 mM Cu(NO₃)₂ and 50 mM KNO₃ can be measured. To perform the measurement, the potential was held at −0.5 V vs. Ag/AgCl to ensure the reduction was mass-transport-limited. FIG. 11 shows a limiting current up to 5.4 times higher was obtained for the Cu NW electrode relative to the carbon paper electrode using the flow reactor of FIG. 8. The line fits are calculations using equation 5 for the overall limiting current from a porous electrode, assuming plug flow. For equation 5, z is the stoichiometric number of electrons involved in the reaction, F is Faraday's constant, Vₑ is the volume of the electrode, kₘ is the mass transport coefficient, Aₑ is the specific surface area of the electrode, and c(L) is the concentrations of the relevant reacting species along the reactor length, L.

$${I}_{L} = zFQc [ 1 - exp ( - \frac{{V}_{e} {k}_{m} {A}_{e}}{Q} ) ] \qquad ( 5 )$$

Here, I_{L} is the limiting current, z=2, F=96485 C mol⁻¹, Q is volumetric flow rate, c is the concentration of Cu(NO₃)₂ at the inlet (0.1 mM), and kₘ is the mass transfer coefficient. At high flow rates, the concentration of reactant across the electrode is constant, and the equation for the limiting current simplifies to equation 6.

I_{L}=zFVₑkₘAₑc (6)

Thus, for a given electrode volume, the maximum current for a given reaction is a function of kₘAₑ. For the case of FIG. 8, the Cu NW electrode has approximately 15 times more surface than the carbon paper, but a mass transport coefficient that is approximately 3 times lower, resulting in an overall current increase of approximately 5 times.

Table 1 shows a comparison of electrical resistivity, specific surface area and porosity for the described Cu NW electrode versus other commercially available materials (carbon paper, graphite felt, reticulated vitreous carbon (RVC), metal screen (mesh) and foam) in the micrometer range.

TABLE 1

| | Carbon | Graphite | | Cu | Ni | Cu NW |
|---|---|---|---|---|---|---|
| | Paper | Felt | RVC | Mesh | Foam | electrode |
| Electrical | 4.7 × 10⁻⁵ | 3 × 10⁻³ | <6.9 × 10⁻³ | ~1 × 10⁻⁷ | <1.5 × 10⁻⁵ | 1.43 × 10⁻⁶ |
| resistivity | | | | | | |
| (Ω · m) | | | | | | |
| Specific | <1.6 × 10⁵ | <4.5 × 10⁴ | <6.8 × 10³ | <2.5 × 10⁴ | <4 × 10⁴ | 2.4 × 10⁶ |
| surface | | | | | | |
| area (m²/m³) | | | | | | |
| Porosity | 0.78-0.80 | 0.92 | 0.97 | 0.61-0.69 | 0.96-0.98 | 0.94 |

Example of Flow Cells for Cu Ion Reduction, ARS Reduction and Organic Electrosynthesis

The example flow cells were fabricated for use in testing the porous electrodes.

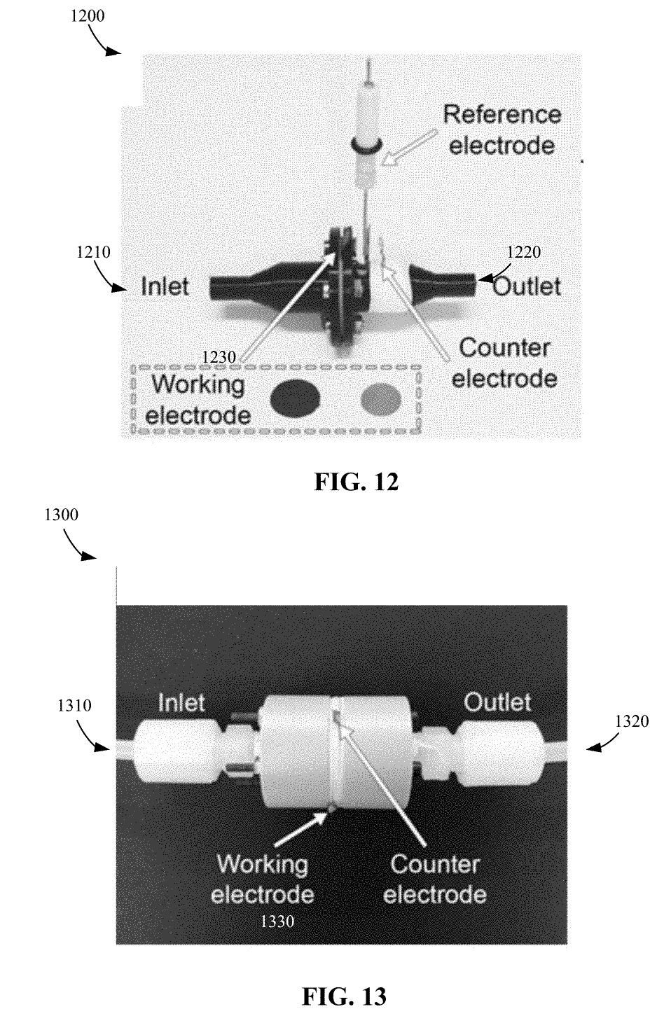

FIG. 12 shows an example of a 3D printed undivided flow cell used to measure water permeability and the reduction of Cu ions and Alizarin Red S (ARS). This flow cell 1200 was made of polyethylene terephthalate glycol (PETG, Hatchbox), which was chosen for its adequate resistance to the sulfuric acid-based electrolytes used during electrochemical reduction. This flow cell 1200 consisted of two parts, an inlet 1210 and an outlet 1220. The porous electrode 1230 was sandwiched between these parts with two gaskets having a 0.5 cm² hole in the center, e.g., the cross-sectional area of the working electrode exposed to liquid flow, giving the following structure: inlet/gasket/electrode/gasket/outlet. The size of the filtered electrode (1.13 cm²) was larger than the size of the hole of the gasket, so the outer part of the electrode was compressed by the gasket to make a robust electrical contact to a stainless steel wire cloth that was placed downstream of the electrode and was connected to a potentiostat. The outlet component had two holes for the reference and counter electrodes. For the measurement of permeability, the outlet component did not have the two holes for the reference and counter electrodes.

Since PETG dissolves in organic solvents, a flow cell for organic synthesis was fabricated by machining polyether ether ketone (PEEK). FIG. 13 shows a flow cell 1300 for electroorganic synthesis. The inlet 1310 and outlet 1320 pieces were threaded for connection to a perfluoroalkoxy alkane (PFA) compression fitting (McMaster). The flow-through electrode 1330 was sandwiched between two gaskets with a diameter of 0.8 cm. The cross-sectional area of the working electrode exposed for liquid flow, which was determined by the hole of the PEEK cell, was 0.5 cm² (diameter: 0.8 cm).

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A three-dimensional (3D) porous electrode, comprising:
a plurality of nanowires arranged in a 3D mesh configuration within a defined area,
wherein nanowires of the plurality of nanowires are sintered to each other at points of contact in the 3D mesh configuration.

2. The 3D porous electrode of claim 1, wherein the nanowires of the plurality of nanowires have diameters between 10 nm-1000 nm.

3. The 3D porous electrode of claim 1, wherein the 3D porous electrode has a thickness of at least 20 μm.

4. The 3D porous electrode of claim 1, wherein the 3D porous electrode has a width of at least 100 μm.

5. The 3D porous electrode of claim 1, wherein the 3D porous electrode has a porosity of at least 70%.

6. The 3D porous electrode of claim 1, wherein the 3D porous electrode has a porosity of at least 90%.

7. The 3D porous electrode of claim 1, wherein the nanowires comprise an electrical conductor.

8. The 3D porous electrode of claim 1, wherein the nanowires comprise Cu.

9. The 3D porous electrode of claim 1, wherein the 3D mesh configuration has a random pattern.

10. An electrochemical reactor system, comprising:
at least one three-dimensional (3D) porous electrode comprising a plurality of nanowires arranged in a 3D mesh configuration within a defined area, wherein nanowires of the plurality of nanowires are sintered to each other at points of contact in the 3D mesh configuration, and wherein each 3D porous electrode of the at least one 3D porous electrode is configured for exposure to a fluid and is coupled to a power source.

11. The system of claim 10, wherein the system is a reduction-oxidation battery and further comprises:
a cathode compartment for receiving a first fluid, wherein a first electrode of the at least one 3D porous electrode is disposed within the cathode compartment such that the first fluid enters through an inlet to the cathode compartment and exits an outlet of the cathode compartment to pass through the first electrode;
an anode compartment for receiving a second fluid, wherein a second electrode of the at least one 3D porous electrode is disposed within the anode compartment such that the second fluid enters through an inlet of the anode compartment and exits an outlet of the anode compartment to pass through the second electrode; and
a membrane positioned between the cathode compartment and the anode compartment.

12. The system of claim 10, wherein the system is a water treatment system and further comprises:
a flow cell receiving a fluid, wherein the at least one 3D porous electrode is positioned between an inlet to the flow cell and an outlet of the flow cell such that the fluid enters the inlet and exits the outlet to pass through the 3D porous electrode.

13. The system of claim 10, wherein the system produces electrochemical organic synthesis and comprises:
a flow cell receiving a fluid, wherein the at least one 3D porous electrode is positioned between an inlet to the flow cell and an outlet of the flow cell such that the fluid enters the inlet and exits the outlet to pass through the 3D porous electrode.

14. A method for manufacturing a three-dimensional (3D) porous electrode, comprising:
dispersing a plurality of nanowires in a solvent to form a nanowire solution, wherein diameters of nanowires of the plurality of nanowires are within a range of 10 nm-1000 nm;
forming a freestanding nanowire electrode in a 3D mesh configuration within a defined area using the nanowire solution; and
annealing the freestanding nanowire electrode to remove surface oxide and sinter points of contact of the plurality of nanowires within the freestanding nanowire electrode.

15. The method of claim 14, wherein the nanowires comprise an electrical conductor.

16. The method of claim 14, wherein forming the freestanding nanowire electrode comprises:
pouring the nanowire solution into a mold of the defined area;
drying the nanowire solution in the mold;
filtering the nanowire solution on the filter with a gasket; and
removing the dried nanowire solution from the mold and the filter to form the freestanding nanowire electrode.

17. The method of claim 16, wherein forming the freestanding nanowire electrode further comprises:
filling the mold with spherical polystyrene particles to a specified volume; and
after pouring the nanowire solution into the mold having the spherical polystyrene particles and drying the nanowire solution into the mold, selectively dissolving the spherical polystyrene particles using an organic solvent.

18. The method of claim 16, wherein forming the freestanding nanowire electrode comprise filtering the nanowire solutions on a mesh support, membrane, carbon paper, or graphite felt.

19. The method of claim 16, wherein drying the nanowire solution in the mold comprises freeze-drying the nanowire solution in the mold.

20. The method of claim 14, wherein forming the freestanding nanowire electrode comprises spray coating the nanowires onto a substrate to form a felt.
